(19) United States
(12) Patent Application Publication
(10) Pub. No.: US 2004/0028888 A1
(43) Pub. Date: Feb. 12, 2004

(54) Three dimensional multilayer RF module having air cavities and method fabricating same

(75) Inventors: Young Chul Lee, Cheongju-si (KR); Chul Soon Park, Daejeon (KR); Byoung Gun Choi, Daegu (KR); Ki Chan Eun, Jeonju-si (KR); Dae Jun Kim, Seoul (KR)

Correspondence Address: BACON & THOMAS, PLLC, 625 SLATERS LANE, FOURTH FLOOR, ALEXANDRIA, VA, 22314

(73) Assignee: Information and Communications University Educational Foundation, Seoul (KR)

(21) Appl. No.: 10/630,746

(22) Filed: Jul. 31, 2003

(30) Foreign Application Priority Data
Aug. 12, 2002 (KR) 2002-47543

(51) Int. Cl. B32B 3/26

(52) U.S. Cl. 428/304.4

(57) ABSTRACT

In a multilayer RF module, a plurality of vertically stacked ceramic layers include a first to a third ceramic layers. Each of the first and the third ceramic layers has a circuit component thereon and the second ceramic layer is located between the first and the third ceramic layers and is provided with at least one or more air cavities filled with air, the air cavities being vertically aligned with the circuit components of the first and the third ceramic layers.

### FIELD OF THE INVENTION

The present invention relates to a three dimensional multilayer RF (Radio Frequency) module; and, more particularly, to a multilayer RF module provided with air cavities of low dielectric constant and a method for the manufacture thereof.

### BACKGROUND OF THE INVENTION

Various technologies have been developed to interconnect integrated circuits (ICs). One of such technologies is based on traditional PCB (printed circuit board) technology. When used to interconnect multiple integrated circuits, such PCB technology is often referred to as MCM-L (Multi-Chip Module Laminate) or laminate MCM technology. The PCB technology typically uses laminates of copper and insulating dielectric material as building blocks to create the required interconnect structures.

In some applications, two or more pieces of laminate are laminated together to form a final structure. Interconnection between laminated layers can be provided by through hole mechanical drilling, followed by plating. The drilling process can require a large amount of board space. Thus the PCB technology, while useful for some applications, is not capable of providing the connection density required in other applications.

In addressing high density interconnect applications, another approach has been proposed, which uses thin film deposition technology and is referred to as DONL (deposited on laminate), MCM-D (Deposited) or MCM deposition technology.

One significant feature of DONL technology is that it creates a high interconnect density substrate using thin film processes on only one side of the PCB. The high density interconnects are formed by depositing alternating conducting and insulating thin film layers.

The DONL process involves first laying down a layer of an insulating dielectric on the top surface of a PCB substrate, depositing a conductive material over the dielectric layer, creating a circuit pattern in the conductive material, then depositing the next insulating and conductive layers. The various layers thus created are connected through vias constructed using a variety of known techniques such as wet chemical etch or laser ablation. In this way, a three dimensional deposited lamination structure is achieved, thereby enabling high density interconnect patterns to be fabricated in small physical areas.

A third conventional approach used to package high density interconnect applications uses cofired ceramic substrates and is generally referred to as MLC (multilayer ceramic), MCM-C(Cofired) or cofired ceramic MCM in the multichip module context. Basically, MCM-C technology involves rolling a ceramic mix into green sheets, drying the green sheets, punching vias, screening the punched sheets with a metal paste representing the trace pattern on the surface of the ceramic, stacking and laminating thus prepared sheets together, then cofiring or sintering the laminated structure to achieve the desired interconnects.

Ceramic has a relatively high dielectric constant. Because of this high dielectric constant, there occurs a significant increase in the capacitive loading of the interconnect nodes between the IC chips in an MCM, especially since several layers of ceramic are present. Capacitive loading degrades frequency performance and increases power dissipation in the MCM. Additionally, a higher dielectric constant lowers the attainable characteristic impedance for many applications. In these applications, a secondary effect of increasing series resistive losses occurs for the interconnects due to smaller conductive cross sections. Therefore, the use of ceramic substrates in multichip modules has been known to limit the performance of the device at frequencies above a few hundred megahertz.

In particular, an LTCC (low temperature cofired ceramic) employed in the aforementioned MCM-C method, having relatively high dielectric constant of about 7.0, yields large dielectric loss and suffers from parasitic capacitance generated in passive elements, such as an inductor and a capacitor, by the ground plane. Such case of a large dielectric loss becomes an issue when fabricating multilayer RF modules over 10 GHz. Furthermore, the parasitic capacitance generated by ground gives rise to the deterioration of the passive element properties such as self-resonance frequency and Q-factor.

### SUMMARY OF THE INVENTION

It is, therefore, a primary object of the present invention to provide a three dimensional multilayer RF module having air cavities formed therein and fabricating method thereof, thereby reducing parasitic capacitance generated between the integrated passive elements and the ground plane.

Another object of the present invention is to provide a three dimensional multilayer RF module having air cavities formed therein and manufacturing method therefor, capable of reducing dielectric loss in transmission lines, e.g., microstrip line, strip, and coplanar waveguide.

Still another object of the present invention is to provide a three dimensional multilayer RF module having air cavities formed therein and fabrication method thereof, capable of increasing interconnect density attributed to reduction of interference among transmission lines and passive elements as a result thereof.

Still another object of the present invention is to provide a three dimensional multilayer RF module having air cavities formed therein and fabrication method thereof, allowing the cavities to be continuously formed, which can be adaptively utilized in aligning optical fibers, reflectors and optical devices in the course of fabricating optical communications module.

In accordance with one aspect of the present invention, there is provided a multilayer RF module, including: a plurality of vertically stacked ceramic layers including a first to a third ceramic layers, wherein each of the first and the third ceramic layers has a circuit component thereon and the second ceramic layer is located between the first and the third ceramic layers and is provided with at least one or more air cavities filled with air, the air cavities being vertically aligned with the circuit components of the first and the third ceramic layers.

In accordance with another aspect of the present invention, there is provided with a method for fabricating a multilayer RF module, including the steps of: preparing at least three green sheets; forming at least one air cavity on one of said at least three green sheets; forming a circuit components on each of two remaining green sheets; stacking said at least three green sheets to thereby form a laminated green sheet structure, wherein the air cavity is located between the circuit components on said two remaining green sheets; and pressing and sintering the laminated green sheet structure.

### BRIEF DISCRIPTION OF THE DRAWINGS

The above and other objects and features of the present invention will become apparent from the following description of preferred a embodiment given in conjunction with the accompanying drawings, in which:

FIG. 1 presents a schematic perspective view of a three dimensional multilayer RF module in accordance with the present invention; and

FIG. 2 provides a cross sectional view illustrating air cavities formed in the three dimensional multilayer RF module of FIG. 1.

### DETAILED DESCRIPTION OF THE PREFERRED EMBODIMENTS

The preferred embodiments of the present invention will now be described with reference to the accompanying drawings.

An MCM substrate of the present invention is fabricated by using the so-called LTCC (low temperature cofired ceramic) process. Low temperature ceramic for LTCC is commercially available, which sinters at approximately 850° C. and exhibits thermal expansion similar to alumina. The low temperature process permits the use of air-fired resistors and also allows for the use of highly conductive metals of Ag and Au.

The LTCC process of the present invention begins with green (or unfired) sheets. Depending on the requirements of a particular MCM being developed, the green sheets are punched or by other means are provided with desirable vias and air cavities. The air cavities of(the present invention are provided together with vias in a same process, not requiring an additional cavity forming process. Thereafter, the conventional vias are filled with a conductive metal forming metal plugs, whereas the air cavities of the present invention are left behind without being filled.

Such air cavities filled with air may take various forms and shapes depending on the nature of the application, for example, a cylindrical shape or a pillar shape having a polygonal cross section. However, the size or the diameter of each cavity is to be preferably not greater than about 100 to 500 μm in order to prevent the cavities from collapsing or being filled by a protruding adjacent green sheet during a subsequent high-pressure lamination process.

The conductive paste is then printed and dried on the thus processed green sheets by employing for example screen printing. Thus prepared metal layers serve as, e.g., ground planes, power planes, transmission lines, passive elements such as resistors, and/or interconnects between the chips.

Then, green sheets are stacked relative to each other such that vias, air cavities and metal layers are appropriately aligned as designed. The laminated green sheets are then pressed, preferably at a temperature of about 70° C. for about 10 min and especially with a pressure of about 2500-2700 psi (10% less than the conventional processing pressure) in order to prevent an extrusion of an adjacent green sheet into the air cavities and/or a cracking or collapsing of the air cavities.

Thereafter, the unsintered laminated structure is diced as required by using a dicing apparatus. The diced unsintered chips are then sintered at a low temperature of about 850° C. of the LTCC process to form MCM substrates on which IC chips and/or modules are to be mounted later.

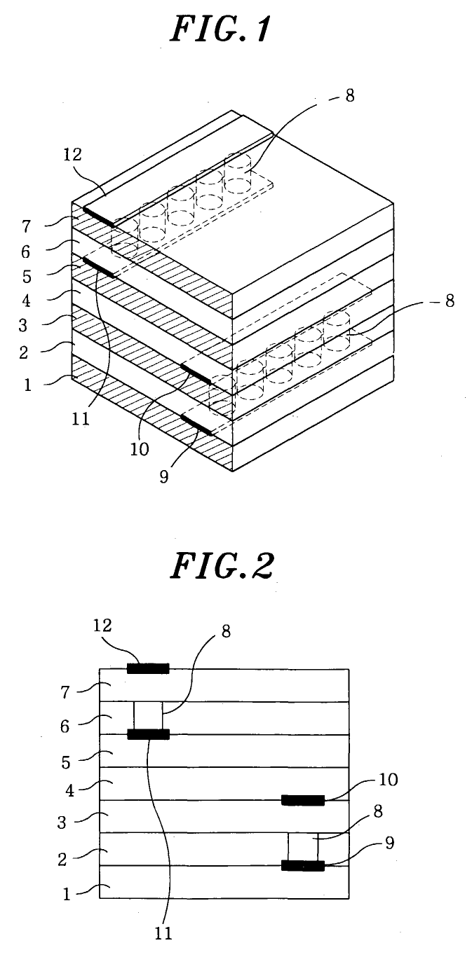

Referring to FIG. 1, there is shown an exemplary three dimensional multilayer RF module with air cavities fabricated therein in accordance with the present invention.

A plurality of laminated ceramic layers 1 to 7 include the layers 2, 6 that are provided with air cavities 8 formed therein. The bottommost layer 1 serves as, e.g., a base of a ground plane; and on the topmost layer 7, e.g., IC chips, modules, transistors and such other circuit components as resistors, capacitors, inductors are mounted. The thickness of a ceramic layer is about 100 μm.

The ceramic layers 1, 3, 5, 7 have thereon metal layers (or patterns) 9 to 12, respectively. As shown, the air cavities 8 in the ceramic layer 2 are located between the overlapping portion of the parallel metal layers 9 and 10; and the air cavities 8 in the ceramic layer 6 are provided between the overlapping portion of the parallel metal layers 11 and 12. The principle behind interposing air cavities 8 between two vertically aligned and overlapping substantially parallel metal layers 9, 10 and 11, 12, that are adjacent to the air cavities 8 may not be limited to the embodiment shown therein. Namely, the metal layers 9, 10 and 11, 12 need not be substantially parallel in order to obtain the advantages of the embodiment of the present invention. The metal layers need not follow such a configuration, but rather can follow different configurations as long as a vertically aligned and overlapping region incorporates one or more air cavities interposed therebetween. Moreover, the metal layers and the air cavities need not be formed at three successive ceramic layers. That is, one or more interposing ceramic layers can be located between a pair of ceramic layers, each having a metal layer thereon and one or more air cavities can be provided in at least one interposing ceramic layer at an overlapping region of the metal layers. Lastly, the air cavities need not be interposed between metal layers only; but rather can be provided at various overlapping regions of any combinations of circuit components including metal lines, passive and active circuit elements, chips and modules, and still achieve the benefits of reducing interference therebetween.

By forming the air cavities 8 having low dielectric constant in the multilayer RF module, dielectric loss in transmission lines, e.g., micro-strip line, strip, and coplanar waveguide, is significantly reduced. Moreover, the generation of parasitic capacitance in circuit components, e.g., passive elements, such as inductor, capacitor, and filter, is also considerably reduced, thereby improving the passive element properties such as self-resonance frequency and Q-factor. Further, by reducing the interference, the interconnect density of a three dimensional muitilayer RF module is greatly enhanced. Furthermore, with the present invention the cavities need not be spaced apart, but can be consecutively arranged to facilitate the arrangement of optical fibers, reflectors and optical elements in fabricating an optical communications module.

While the invention has been shown and described with respect to the preferred embodiment, it will be understood to those skilled in the art that various changes and modifications may be made without departing from the spirit and scope of the invention as defined in the following claims.

What is claimed is:

1. A multilayer RF module, comprising:
a plurality of vertically stacked ceramic layers including a first to a third ceramic layers,
wherein each of the first and the third ceramic layers has a circuit component thereon and the second ceramic layer is located between the first and the third ceramic layers and is provided with at least one or more air cavities filled with air, the air cavities being vertically aligned with the circuit components of the first and the third ceramic layers.

2. The multilayer RF module of claim 1, wherein the air cavities have a cylindrical shape.

3. The multilayer RF module of claim 2, wherein the air cavities have a diameter smaller than 100 to 500 μm.

4. The multilayer RF module of claim 1, wherein the circuit component is a metal pattern.

5. A method for fabricating a multilayer RF module, comprising the steps of:
preparing at least three green sheets;
forming at least one air cavity on one of said at least three green sheets;
forming a circuit components on each of two remaining green sheets;
stacking said at least three green sheets to thereby form a laminated green sheet structure, wherein the air cavity is located between the circuit components on said two remaining green sheets; and
pressing and sintering the laminated green sheet structure.

6. The method for fabricating a multilayer RF module of claim 5, wherein said at least one air cavity has a cylindrical shape.

7. The method for fabricating a multilayer RF module of claim 6, wherein the air cavity has a diameter smaller than about 100 to 500 μm.

8. The method for fabricating a multilayer RF module of claim 5, wherein the laminated green sheet structure pressing step is carried out at a temperature of about 70° C. and at a pressure of about 2500-2700 psi for about 10 min.

9. The method for fabricating a multilayer RF module of claim 5, wherein the circuit component is a metal pattern.
